(19) United States
(12) Patent Application Publication
(10) Pub. No.: US 2020/0121129 A1
(43) Pub. Date: Apr. 23, 2020

(54) Cabinet with enclosures for keeping food products at a hot temperature

(71) Applicant: ROTISOL, CHELLES (FR)

(72) Inventor: Franck WITTIG, NOGENT SUR MARNE (FR)

(21) Appl. No.: 16/605,823

(22) PCT Filed: Feb. 19, 2018
(86) PCT No.: PCT/FR2018/050383

§ 371 Date: Oct. 17, 2019

(30) Foreign Application Priority Data
Apr. 18, 2017 (FR) 17 53354

(51) Int. Cl. A47J 39/00

(52) U.S. Cl. CPC A47J 39/003

(57) ABSTRACT

Cabinet with enclosures for keeping food products at a hot temperature, in which each enclosure (2) is defined by two side walls (3), a back wall (4), a front face (5) that is open or can be opened, a top wall (6) and a bottom shelf (7), each enclosure comprising, over the entire width thereof:
on the outside and behind the bottom shelf (7), a cylindrical turbine (8) for circulating air;
at the base of the back wall (4), louvers (9) for air to pass from inside the enclosure to the cylindrical turbine (8);
in the bottom shelf (7), between a top face (13) carrying the food products (18) and a bottom face, a space (20) for air to pass between the cylindrical turbine (8) and a front hatch (14) open toward the inside of the enclosure (2); and
in the air passage space (20), heating elements (11) distributed over the entire surface of the shelf (7), heating the top face (13) of the shelf and the air circulated by the cylindrical turbine (8).

### FIELD OF THE INVENTION

The invention concerns a cabinet with enclosures for keeping food products at a hot temperature. The invention more particularly concerns a cabinet with enclosures for keeping food products, such as cooked poultry or ready meals, at a temperature between 63° C. and 70° C. inclusive at the core of the products, whatever their location on a shelf of the enclosure. In fact, below 63° C. there is a pathogenic risk and above 70° C. there is further cooking of the products. The food products are packaged and accessible on a self-service basis in the cabinet which includes an accessible, open or openable front face.

### PRIOR ART

The document EP 2 916 692 describes an enclosure with an open front for keeping foods at a hot temperature, with thermally insulative walls, the rear face of which includes a removable panel carrying an adjustable mechanism for setting the temperature in the inside space.

The document EP 3 048 931 describes a display case with a plurality of enclosures for displaying and storing foods, each enclosure including a temperature control device adjustable as a function of the nature of the food to be stored and the time to maintain the temperature.

The temperature in self-service display cases is generally adjusted by means of a thermostatic probe positioned in the food display enclosure or near the heating elements.

A self-service display case enclosure is usually heated by means of radiant electrical elements and/or heating lamps placed above a shelf displaying the food products. The heating members are positioned so as not to cause difficulty in placing and picking up foods on the shelf and hazards for the persons involved in those operations. This results in an uneven distribution of heat.

Another heating means used for self-service display cases consists of a fan the axial flow of air from which is directed onto heating elements and then onto the foods. This disposition does not ensure an even temperature in the display case and risks food products not maintained at the required temperature being rendered unfit to eat.

### OBJECT AND SUMMARY

An object of the present invention is to avoid the aforementioned disadvantages by ensuring an even temperature in the enclosure and maintaining the temperature between the limits of 63° C. and 70° C. under optimum energy consumption conditions, that is to say, for example, at the nominal voltage of 230 V accessible anywhere in a store or, for display cases of large capacity, a three-phase voltage of 400 V.

The invention consists in a cabinet with enclosures for keeping food products at a hot temperature, in which each enclosure is defined by two side walls, a back wall, a front face that is open or can be opened, a top wall and a bottom shelf, characterized in that each enclosure comprises, over the entire width thereof:

on the outside and behind the bottom shelf, a cylindrical turbine for circulating air;

at the base of the back wall, louvers for air to pass from inside the enclosure to the cylindrical turbine;

in the bottom shelf, between a top face carrying the food products and a bottom face, a space for air to pass between the cylindrical turbine and a front hatch that open toward the inside of the enclosure; and

in the air passage space, heating elements distributed over the entire surface of the shelf, heating the top face of the shelf and the air circulated by the cylindrical turbine.

The front hatch open toward the inside of the enclosure is advantageously flanked at the front by a flap redirecting air circulating in the shelf upward and toward the inside of the enclosure.

According to one embodiment, the front face of the enclosure is provided with a swinging door.

### BRIEF DESCRIPTION OF THE DRAWINGS

The invention is described hereinafter with reference to the appended drawings in which:

FIG. 1 is a side view of one embodiment of a cabinet with enclosures for keeping food products at a hot temperature;

FIG. 2 is a side view of an enclosure from FIG. 1;

FIG. 3 is a perspective view of an enclosure from FIG. 1 showing the circulation of the flow of air;

FIG. 4 is a view analogous to FIG. 3 with food products absent to show the space in the shelf for the passage of air;

FIG. 5 is a side view of an enclosure from FIG. 1 showing the passage in the bottom shelf for the flow of air;

FIG. 6 is a perspective view from the rear of an enclosure from FIG. 1;

FIG. 7 is a perspective view of a shelf of the cabinet from FIG. 1, with the top face removed.

### DETAILED DESCRIPTION

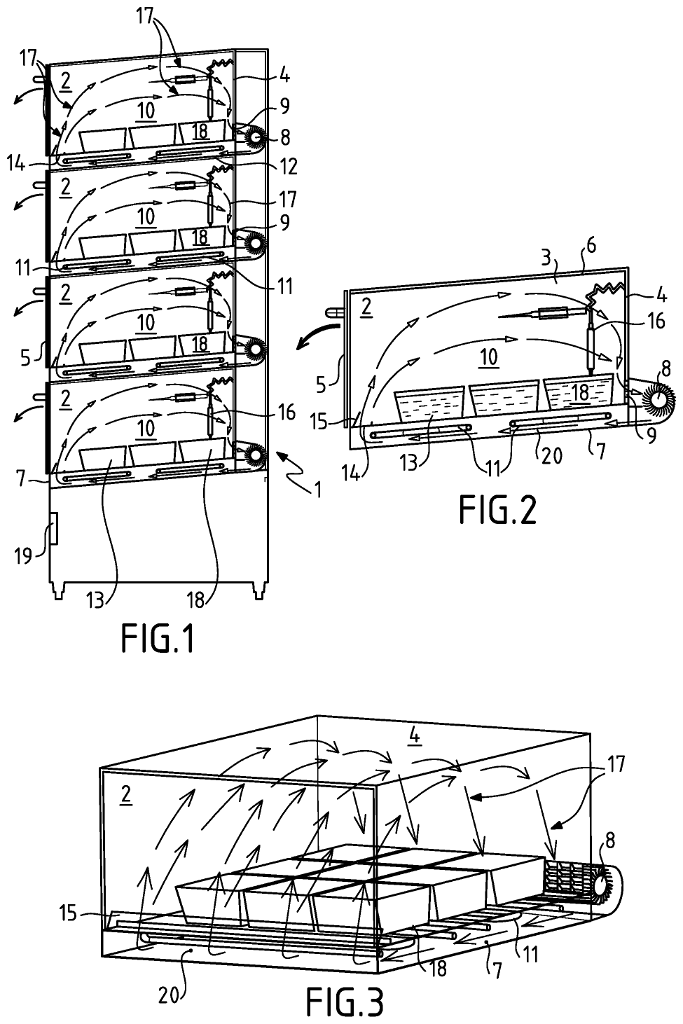

The cabinet 1 with enclosures 2 for keeping food products at a hot temperature includes a plurality of stacked enclosures 2 (FIG. 1). Each enclosure 2 includes two side walls 3, a back wall 4, an open or openable front face 5, a top wall 6 and a bottom shelf 7. Behind the bottom shelf 7 (FIG. 2) is disposed a cylindrical turbine 8 the length of which corresponds to the width of the shelf 7, that is to say to the width of the enclosure 2. The back wall of the enclosure 2 has in its bottom part louvers 9 disposed across the entire width of the enclosure 2 (FIG. 6).

The bottom shelf 7 has a bottom face 12, a top face 13 and between the two faces a space 20 for passage of air that is circulated from the back toward the front of the shelf 7 by the cylindrical turbine 8. In this air passage space 20 are disposed heating elements 11 which are for example sheathed hairpin-shaped electrical resistances distributed across all of the surface of the shelf from the back toward the front (FIG. 7).

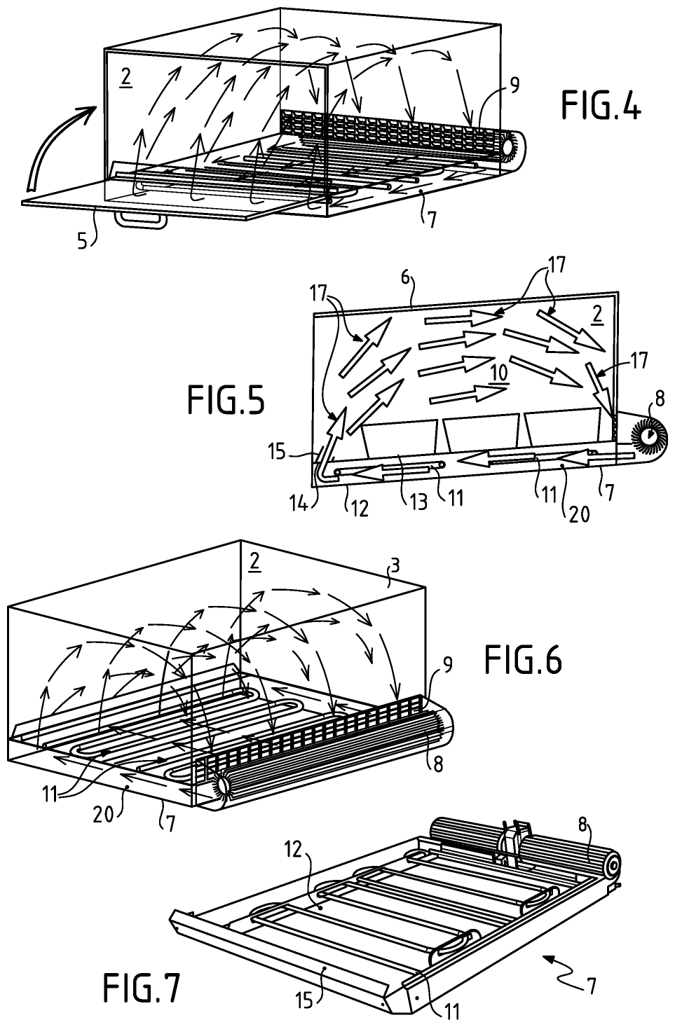

Near the front face 5 of the enclosure 2 the top face 13 of the shelf includes a hatch 14 (FIG. 2) that extends over all of the width of the shelf and is flanked at the front by a flap 15 for redirecting the flow of air circulating in the shelf 7 upward and toward the inside of the enclosure 2 (FIG. 3). The presence of this flap 15 ensures that all of the flow of hot air, symbolized by the arrow 17, circulates from front to back in the enclosure 2, surrounding the set 10 of products to be kept at a hot temperature. The flow of air is taken up via the louvers 9 by the cylindrical turbine 8. Because the cylindrical turbine 8 has a length substantially equal to the width of the enclosure 2 the flow of air circulates in the shelf and in the enclosure virtually without transverse turbulence. The flow of air regularly sweeps all the width of the enclosure, from front to back, with very little exchange with the outside of the enclosure 2. To save energy it is advantageous to dispose on the front face 5 of the enclosure a swinging door that can be opened on demand (FIG. 4).

In the cabinet with enclosures according to the invention the temperature at the core of the food products kept at a hot temperature must be between 63° C. and 70° C. inclusive. To control this temperature a thermostatic probe 16 is positioned in the enclosure 2, embedded or not in the products. It may equally be positioned in the flow of air at the outlet of the hatch 14. Its threshold temperature is regulated by an electronic circuit 19 installed in the cabinet 1, for example at the bottom of the cabinet 1 (FIG. 1) or in a strip at the top (not shown). The heating elements 11 of the bottom shelf 7 on the one hand provide the heating necessary for the top face 13 of the shelf 7, which is in contact with the food products 18, and on the other hand the heating of the flow of air circulated in the enclosure 2 by the cylindrical turbine 8. The control electronic circuit 19 enables the nominal temperature of each enclosure of the cabinet to be controlled in distinct ranges of values.

1. A cabinet with enclosures for keeping food products at a hot temperature, in which each enclosure is defined by two side walls, a back wall, a front face that is open or can be opened, a top wall and a bottom shelf, each enclosure comprising, over the entire width thereof,
on the outside and behind the bottom shelf, a cylindrical turbine for circulating air;
at the base of the back wall, louvers for air to pass from inside the enclosure to the cylindrical turbine;
in the bottom shelf, between a top face carrying the food products and a bottom face, a space for air to pass between the cylindrical turbine and a front hatch open toward the inside of the enclosure; and
in the air passage space, heating elements distributed over the entire surface of the shelf, heating the top face of the shelf and the air circulated by the cylindrical turbine.

2. The cabinet as claimed in claim 1 wherein the front hatch open toward the inside of the enclosure is flanked at the front by a flap redirecting air circulating in the shelf upward and toward the inside of the enclosure.

3. The cabinet as claimed in claim 1 wherein the front face of the enclosure is provided with a swinging door.
